(19) United States
(12) Patent Application Publication
(10) Pub. No.: US 2025/0388258 A1
(43) Pub. Date: Dec. 25, 2025

(54) APPARATUS FOR REDUCING VIBRATION OF ELECTRIC POWER STEERING SYSTEM

(71) Applicant: HYUNDAI MOBIS CO., LTD., Seoul (KR)

(72) Inventors: Han Wul KIM, Yongin-si (KR); In Hyuk KIM, Yongin-si (KR); Kyu Ha KIM, Yongin-si (KR); Kwang Woong KIM, Yongin-si (KR)

(73) Assignee: HYUNDAI MOBIS CO., LTD., Seoul (KR)

(21) Appl. No.: 19/243,918

(22) Filed: Jun. 20, 2025

(30) Foreign Application Priority Data
Jun. 21, 2024 (KR) 10-2024-0081171

(51) Int. Cl. B62D 5/04; H02P 23/04

(52) U.S. Cl. CPC B62D 5/0472; H02P 23/04

(57) ABSTRACT

According to an embodiment, there is provided a vibration reduction apparatus of an electric power steering (EPS) system, including a filter unit configured to extract a disturbance frequency signal from a torque signal detected by a torque sensor of the EPS system, and an adaptive control unit configured to estimate a disturbance parameter and a frequency response parameter of the EPS system using a vibration frequency of a disturbance of the EPS system and the disturbance frequency signal and calculate a disturbance compensation signal using the disturbance parameter and the frequency response parameter.

### CROSS-REFERENCE TO RELATED APPLICATION

This application claims priority to and the benefit of Korean Patent Application No. 10-2024-0081171, filed on Jun. 21, 2024, the disclosure of which is incorporated herein by reference in its entirety.

### BACKGROUND

### 1. Field of the Invention

One embodiment of the present invention relates to a vibration reduction apparatus of an electric power steering (EPS) system.

### 2. Discussion of Related Art

Vibration disturbance generated in a vehicle is transmitted to a steering system and becomes a factor that causes vibration and discomfort to a driver. For this reason, methods for suppressing the effect of vibration disturbance on electric power steering (EPS) are being developed.

Existing technologies may appropriately change control parameters according to required performance without dynamic modeling of a complex system, but there is a problem in that the required performance may not be met depending on the influence of the system or the magnitude of disturbance.

### SUMMARY OF THE INVENTION

The present invention is directed to providing a vibration reduction apparatus of an electric power steering (EPS) system capable of minimizing or eliminating disturbance affecting the performance of the EPS system.

According to an aspect of the present invention, there is provided a vibration reduction apparatus of an electric power steering (EPS) system, including a filter unit configured to extract a disturbance frequency signal from a torque signal detected by a torque sensor of the EPS system and an adaptive control unit configured to estimate a disturbance parameter and a frequency response parameter of the EPS system using a vibration frequency of a disturbance of the EPS system and the disturbance frequency signal and calculate a disturbance compensation signal using the disturbance parameter and the frequency response parameter.

The adaptive control unit may include a first calculation unit configured to calculate error partial differentiation of the vibration frequency and the disturbance compensation signal, a second calculation unit configured to calculate the disturbance parameter and the frequency response parameter using a calculation result of the error partial differentiation and the disturbance frequency signal, and a compensation signal calculation unit configured to calculate the disturbance compensation signal using the disturbance parameter and the frequency response parameter.

The second calculation unit may calculate the disturbance parameter and the frequency response parameter through a calculation process of minimizing an objective function of the torque signal from the calculation result of the error partial differentiation and the disturbance frequency signal.

The adaptive control unit may further include a third calculation unit configured to limit a maximum value of the disturbance parameter according to a preset first reference value and limit a minimum value of the frequency response parameter according to a preset second reference value.

The compensation signal calculation unit may calculate the disturbance compensation signal through a product operation between a matrix value of the disturbance parameter and an inverse matrix value of the frequency response parameter.

The EPS system may output a motor current command using an EPS control logic signal and the disturbance compensation signal.

The vibration reduction apparatus may further include a system damping control unit configured to control an amount of change in at least one of a magnitude and a phase at a resonance frequency of the EPS system using the torque signal as an input.

The system damping control unit may output a damping control signal that limits the amount of change in at least one of the magnitude and the phase at the resonance frequency of the EPS system to within a preset range using the torque signal as the input.

The EPS system may output a motor current command using an EPS control logic signal, the disturbance compensation signal, and the damping control signal.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram of a vibration reduction apparatus of an electric power steering (EPS) system according to an embodiment;

FIG. 2 is a view for describing the operation of a filter unit according to the embodiment;

FIG. 3 is a conceptual diagram of a system damping control unit according to the embodiment;

FIG. 4 is a view for describing the operation of the system damping control unit according to the embodiment;

FIGS. 5 to 9 are views for describing the operation of an adaptive control unit according to the embodiment; and

FIGS. 10 and 11 are views for describing test results of the vibration reduction apparatus of the EPS system according to the embodiment.

### DETAILED DESCRIPTION OF EXEMPLARY EMBODIMENTS

Hereinafter, preferred embodiments of the present invention will be described in detail with reference to the accompanying drawings.

However, the technical idea of the present invention is not limited to some embodiments to be described but may be implemented in various different forms, and within the scope of the technical idea of the present invention, one or more among components in the embodiments may be used by being selectively combined and substituted.

Further, unless specifically defined and described, terms used in the embodiments of the present invention (including technical and scientific terms) may be interpreted as meanings which are generally understood by those skilled in the art to which the present invention pertains, and commonly used terms such as terms defined in dictionaries may be interpreted in consideration of the contextual meaning of the related art.

The terms used in the embodiments of the present invention are for the purpose of describing the embodiments only and are not intended to limit the invention.

In the present specification, the singular forms may include the plural forms unless the context clearly dictates otherwise, and when described as “at least one (or one or more) among A, B, and (or) C,” it may include one or more of all possible combinations of A, B, and C.

In addition, when describing components of embodiments of the present invention, terms such as first, second, A, B, (a), (b), etc., may be used.

These terms are only for distinguishing the components from other components, and the essence, sequence, or order of the components is not limited by these terms.

In addition, when a component is described as being “linked,” “coupled,” or “connected” to another component, the component is not only directly linked, coupled, or connected to another component, but also “linked,” “coupled,” or “connected” to another component with still another component disposed between the component and the other component.

Further, when a component is described as being formed or disposed “on (above) or under (below)” another component, the term “on (above) or under (below)” includes not only when two components are in direct contact with each other, but also when one or more other components are formed or disposed between the two components. Further, when a component is described as being “on (above) or below (under),” the description may include the meanings of an upward direction and a downward direction based on one component.

Hereinafter, embodiments will be described in detail with reference to the accompanying drawings, but the same or corresponding components are denoted by the same reference numerals regardless of the drawing numbers, and redundant descriptions thereof will be omitted.

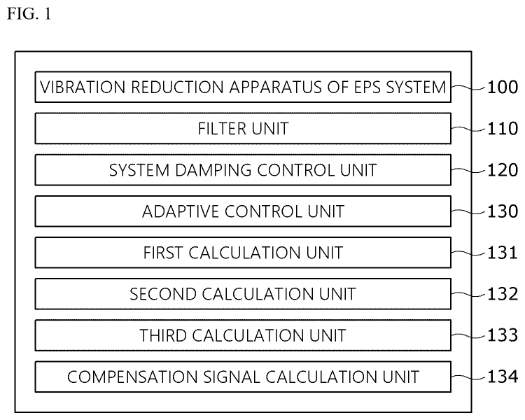

FIG. 1 is a block diagram of a vibration reduction apparatus of an electric power steering (EPS) system according to an embodiment. Referring to FIG. 1, the EPS system or motor driven power steering (MDPS) system determines driving conditions of a vehicle through a torque sensor that measures steering torque of a driver input to a steering wheel, a steering angle sensor that measures a steering angle or steering angle velocity of the steering wheel, and a vehicle speed sensor that measures a vehicle speed, and provides auxiliary torque through an electric motor based on the steering torque applied to a steering shaft as the driver steers the steering wheel.

In this process, the EPS system may be affected by vibration caused by vehicle resonance, and a current command of the EPS system may also be affected by the vibration. That is, a current command for motor control of the EPS system from an EPS controller of the EPS system may also include a disturbance component.

In a torque signal detected by the torque sensor, driver torque, measurement noise, disturbance torque, and compensation torque may be included. In particular, the disturbance torque may be included in the torque signal due to vibration of a rack bar.

A vibration reduction apparatus 100 of the EPS system according to the embodiment may include a filter unit 110, a system damping control unit 120, and an adaptive control unit 130. The vibration reduction apparatus 100 of the EPS system according to the embodiment may suppress the vibration generated from disturbance factors through control input adjustment, thereby making the driver insensitive to the disturbance.

The filter unit 110 may extract a disturbance frequency signal from the torque signal detected by the torque sensor of the EPS system. The filter unit 110 may perform the role of extracting only a specific frequency signal from the torque signal of the EPS system. The filter unit 110 may identify the occurrence of disturbance by extracting only the disturbance frequency signal from the torque signal of the EPS system.

The filter unit 110 may be configured as a band pass filter, and may filter a torque signal detected by a torque sensor to output an error signal from the torque signal. The torque signal detected by the torque sensor contains a disturbance component, and the signal that has passed through the band pass filter may be used in control logic for disturbance suppression. In some implementations, the filter unit may be referred to as a filter. In some implementations, the system damping control unit 120, and the adaptive control unit 130 may be a hardware device implemented by various electronic circuits (e.g., computer, microprocessor, CPU, ASIC, circuitry, logic circuits, etc.). The processor may be implemented by a non-transitory memory storing, e.g., a program(s), software instructions reproducing algorithms, etc., which, when executed, performs various functions described hereinafter, and a processor configured to execute the program(s), software instructions reproducing algorithms, etc. Herein, the memory and the processor may be implemented as separate semiconductor circuits. Alternatively, the memory and the processor may be implemented as a single integrated semiconductor circuit. The processor may embody one or more processor(s). In some implementations, the system damping control unit 120 may be referred to as a system damping controller, and the adaptive control unit 130 may be referred to as an adaptive controller.

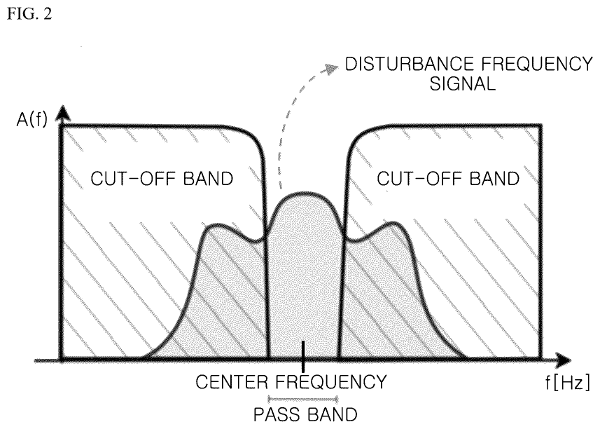

FIG. 2 is a view for describing the operation of the filter unit 110 according to the embodiment. In FIG. 2, for torque signals, only signals of a center frequency band may pass through, and signals outside the center frequency band may be blocked. Signals in a pass band that have pass through a band pass filter may be extracted as disturbance frequency signals. In FIG. 2, the center frequency may be set using the center frequency of a vibration frequency.

The filter unit 110 may detect a vibration frequency of the wheel due to disturbance and set the center frequency of the band pass filter using the vibration frequency of the wheel. The vibration frequency may be calculated from a speed of the vehicle and an angular velocity of the motor.

Therefore, the torque signal and vibration frequency detected by the torque sensor of the EPS system may be input to the filter unit 110. In addition, the band pass filter of the filter unit 110 is set using the center frequency of the vibration frequency, and when the torque signal passes through the band pass, the disturbance frequency signal may be output.

The filter unit 110 may calculate a transfer function of the band pass filter according to the following Equation 1.

$${G}_{BPF} ( s ) = \frac{K ( \frac{{W}_{0}}{Q} ) s}{{s}^{2} + \frac{{W}_{0}}{Q} s + {W}_{0}^{2}} , Q : {W}_{0} / ( {W}_{H} - {W}_{L} ) \qquad [ Equation 1 ]$$

In Equation 1, WO is the center frequency, K is a filter gain value, and Q is a bandwidth adjustment parameter.

The system damping control unit 120 may control the amount of change in at least one of a magnitude and a phase at a resonance frequency of the EPS system using a torque signal detected by the torque sensor of the EPS system as an input.

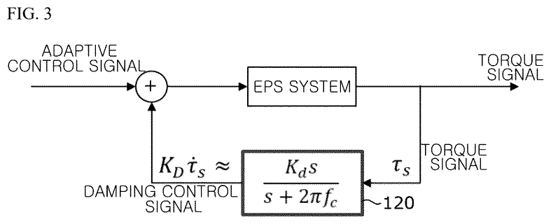

Referring to FIG. 3, the system damping control unit 120 may output a damping control signal that limits the amount of change in at least one of the magnitude and the phase at a resonance frequency of the system to within a preset range using a torque signal as an input. The system damping control unit 120 may constitute a feedback circuit between an input and output of the EPS system. The input of the system damping control unit 120 is a torque signal that is an output of the EPS system, and the system damping control unit 120 may transmit an output proportional to a differential value of an error signal appearing between a reference signal and an output signal to the adaptive control unit 130. In this case, the output of the system damping control unit 120 may be calculated using a differential value and gain Kd of the torque signal. The system damping control unit 120 may perform a differentiation operation using a high pass filter.

The system damping control unit 120 may calculate parameter values for increasing damping by applying Kd dτₛ/dt to a current value iq of a torque signal transfer function of the EPS system according to the following Equation 2 and Equation 3.

$$[ \begin{matrix}{\dot{τ}}_{s} \\ {\ddot{τ}}_{s}\end{matrix} ] = [ \begin{matrix}0 & 1 \\ - {K}_{c} ( \frac{1}{{J}_{1}} + \frac{1}{{J}_{2}} ) & - \frac{{C}_{1}}{{J}_{1}}\end{matrix} ] [ \begin{matrix}{τ}_{s} \\ {\dot{τ}}_{s}\end{matrix} ] + [ \begin{matrix}0 \\ - \frac{{K}_{c}}{{J}_{2}} N\end{matrix} ] {K}_{t} {i}_{q} + f ( t ) \qquad [ Equation 2 ]$$

$$\begin{matrix}Open Loop : \\ {s}^{2} + \frac{{C}_{1}}{{J}_{1}} s + {K}_{c} ( \frac{1}{{J}_{1}} + \frac{1}{{J}_{2}} ) ,\end{matrix} \begin{matrix}Control Applied : \\ {s}^{2} + ( \frac{{C}_{1}}{{J}_{1}} + \frac{{K}_{c} {NK}_{t}}{{J}_{2}} {K}_{D} ) s + {K}_{c} ( \frac{1}{{J}_{1}} + \frac{1}{{J}_{2}} )\end{matrix} \qquad [ Equation 3 ]$$

In Equations 2 and 3, Ts is a torque signal, J₁ and J₂ are moments of inertia, N is a gear ratio, C₁ is a damping coefficient, K_{c} is a torsion bar stiffness, Kₜ is a motor torque constant, f(t) is an unmodeled dynamics, and i_{q} is a current command value.

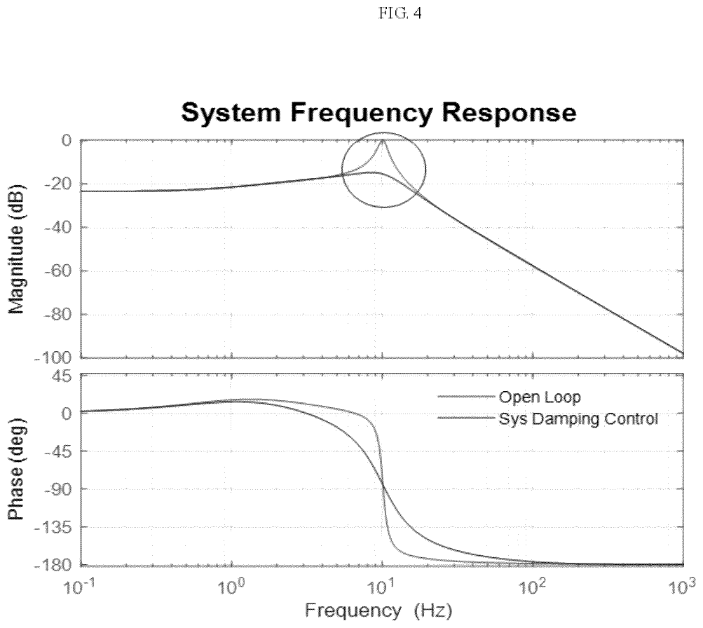

Referring to FIG. 4, the system damping control unit 120 transmits the damping control signal to the adaptive control unit 130 so that the damping control signal is reflected in a compensation signal, thereby preventing a rapid increase in a frequency response magnitude or a rapid change in phase at a resonance frequency of the system. In the case of an open loop to which the system damping control unit 120 is not applied, it can be seen that the magnitude rapidly increases or the phase rapidly decreases in a resonance frequency band. In comparison, when the system damping control unit 120 according to the embodiment is applied, it can be seen that the magnitude may be prevented from rapidly increasing and the phase decreases with a gentle slope in the resonance frequency band.

The adaptive control unit 130 detects an error signal generated by the disturbance in the torque signal of the torque sensor that detects the steering torque of the EPS system. The adaptive control unit 130 generates a compensation signal to compensate for a disturbance signal using the detected error signal.

The adaptive control unit 130 may estimate disturbance parameters and frequency response parameters of the EPS system using the vibration frequency of the disturbance and the disturbance frequency signal of the EPS system, and calculate a disturbance compensation signal using the disturbance parameters and frequency response parameters.

The adaptive control unit 130 may detect a vibration frequency of the wheel due to the disturbance. The vibration frequency may be calculated from the speed of the vehicle and the angular velocity of the motor.

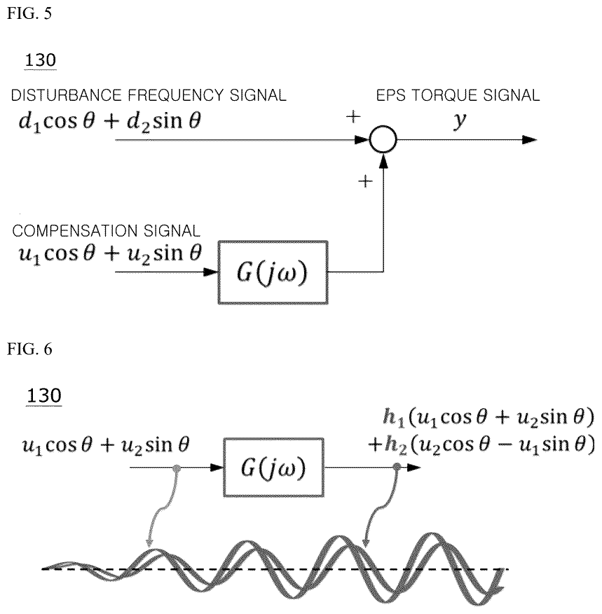

Referring to FIGS. 5 and 6, the adaptive control unit 130 may generate a basis function (sin θ, cos θ) of the compensation signal using the vibration frequency of the disturbance, generate the compensation signal (u1 cos θ, u2 sinθ) using the generated basis function, and adjust the compensation signal to offset the disturbance signal according to the generated error signal.

The torque signal that is the output of the EPS system may be calculated as the sum of the disturbance frequency signal and the compensation signal in the time dimension as shown in the following Equation 4.

$$y ( t ) = {h}_{1} ( {u}_{1} cos θ + {u}_{2} sin θ ) + {h}_{2} ( {u}_{2} cos θ - {u}_{1} sin θ ) + cos θ + sin θ \qquad [ Equation 4 ]$$

In Equation 4, y(t) is a torque signal in the time dimension, h₁(u₁ cos θ(+u₂ sin θ)+h₂(u₂ cos θ−u₁ sin θ) on the right-hand side is a compensation signal passing through a compensation signal transmission system, and d₁ cos θ+d₂ sin θ is a disturbance frequency signal. In Equation 4, h1 and h2 may refer to parameters for determining a magnitude and a phase of a system frequency response. In addition, d1 and d2 may refer to parameters for determining the magnitude and the phase of the disturbance frequency signal.

The compensation signal transmission system G(jw) of Equation 4 may be set Equation 5 below as the frequency response.

$$G ( j ω ) = {h}_{1} + j {h}_{2} \qquad [ Equation 5 ]$$

When the expression in Equation 5 is organized into a determinant, Equation 5 may be defined as Equation 6 below.

$$y ( t ) = [ \begin{matrix}cos θ & sin θ\end{matrix} ] \frac{H}{( [ \begin{matrix}{h}_{1} & {h}_{2} \\ - {h}_{2} & {h}_{1}\end{matrix} ]} \frac{u}{[ \begin{matrix}{u}_{1} \\ {u}_{2}\end{matrix} ]} + \frac{d}{[ \begin{matrix}{d}_{1} \\ {d}_{2}\end{matrix} ] )} , \begin{matrix}Hu + d \\ = H ( - {H}^{- 1} d ) + d \\ = {0}_{2 \times 1}\end{matrix} \qquad [ Equation 6 ]$$

In Equation 6, the torque signal may be calculated according to a product operation of a basis signal and a frequency response H of the system, a compensation signal u, and a disturbance frequency signal d. Accordingly, it can be seen that the adaptive control unit 130 may calculate a compensation signal that may maximize a disturbance compensation effect through the product operation of an inverse function of the frequency response of the system and the disturbance frequency signal. In this way, the adaptive control unit 130 may minimize the disturbance frequency signal through the compensation signal, and may estimate the frequency response of the system and the disturbance frequency signal and then calculate the compensation signal.

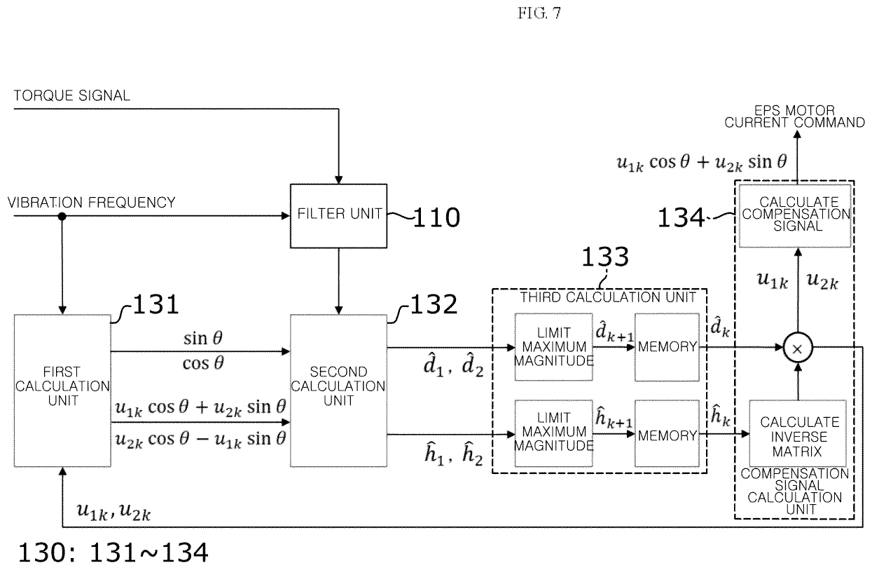

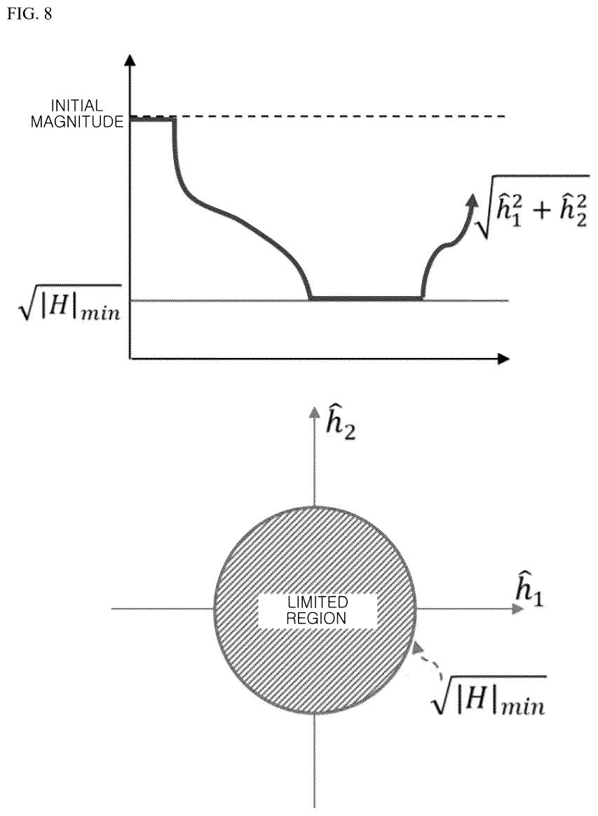

Referring to FIG. 7, the adaptive control unit 130 may include a first calculation unit 131 that calculates error partial differentiation of the vibration frequency and the disturbance compensation signal, a second calculation unit 132 that calculates disturbance parameters and frequency response parameters using a calculation result of the error partial differentiation and the disturbance frequency signal, a third calculation unit 133 that adjusts the parameter values, and a compensation signal calculation unit 134 that calculates the disturbance compensation signal using the disturbance parameter and the frequency response parameter. The first calculation unit 131, the second calculation unit 132, the third calculation unit 133 and the compensation signal calculation unit 134 may be implemented as a processor (e.g., computer, microprocessor, CPU, ASIC, circuitry, logic circuits, etc.) and an associated non-transitory memory storing software instructions which, when executed by the processor, provides the functionalities of the first calculation unit 131, the second calculation unit 132, the third calculation unit 133 and the compensation signal calculation unit 134.

The first calculation unit 131 may calculate the basis function (sin θ, cos θ) of the compensation signal through error partial differentiation operation of the vibration frequency.

In addition, the first calculation unit 131 may receive the disturbance compensation signal output from the compensation signal calculation unit as a feedback signal and partially differentiate the received disturbance compensation signal to calculate a partial differentiation function (u1k cos θ+u2k sin θ, u2k cos θ−u1k sin θ) of the disturbance compensation signal. In the disturbance compensation signal, u₁ and u₂ may refer to parameters for determining the magnitude and the phase of the compensation signal.

The second calculation unit 132 may calculate disturbance parameters and frequency response parameters through a calculating process that minimizes an objective function of the torque signal from the error partial differentiation operation result and the disturbance frequency signal.

The second calculation unit 132 may calculate an estimated torque signal ŷ(t) through the following Equations 7 and 8 and calculate an objective function e² that is a difference value between the torque signal and the estimated torque signal.

$$\hat{y} ( t ) = {\hat{h}}_{1} ( {u}_{1} cos θ + {u}_{2} sin θ ) + {\hat{h}}_{2} ( {u}_{1} cos θ - {u}_{2} sin θ ) + {\hat{d}}_{1} cos θ + {\hat{d}}_{2} sin θ \qquad [ Equation 7 ]$$

$${( y - \hat{y} )}^{2} = {e}^{2} \qquad [ Equation 8 ]$$

In Equations 7 and 8, ĥ1 and ĥ2 may refer to estimated parameters for determining the magnitude and the phase of the system frequency response. In addition, d′1 and d′2 may refer to estimated parameters for determining the magnitude and the phase of the disturbance frequency signal.

The second calculation unit 132 may calculate parameters (ĥ₁ĥ₂,\hat{d}₁,\hat{d}₂) for minimizing the objective function e² according to Equations 9 and 10.

$$\begin{matrix}\frac{\partial {e}^{2}}{\partial x} = \frac{\partial e}{\partial x} \frac{\partial {e}^{2}}{\partial e} = 2 \cdot \frac{\partial e}{\partial x} \cdot e \\ [ \begin{matrix}{\hat{d}}_{1 ( k + 1 )} \\ {\hat{d}}_{2 ( k + 1 )}\end{matrix} ] = [ \begin{matrix}{\hat{d}}_{1 k} \\ {\hat{d}}_{2 k}\end{matrix} ] + η \cdot {μ}_{d} [ \begin{matrix}cos θ \\ sin θ\end{matrix} ] {e}_{k} \cdot [ \begin{matrix}{\hat{h}}_{1 ( k + 1 )} \\ {\hat{h}}_{2 ( k + 1 )}\end{matrix} ] = [ \begin{matrix}{\hat{h}}_{1 k} \\ {\hat{h}}_{2 k}\end{matrix} ] + η \cdot {μ}_{h} [ \begin{matrix}{u}_{1} cos θ + {μ}_{2} sin θ \\ {u}_{2} cos θ + {μ}_{1} sin θ\end{matrix} ] {e}_{k}\end{matrix} \qquad [ Equation 9 ]$$

$$η = \frac{1}{v + {‖ u ‖}_{2}^{2}} \qquad [ Equation 10 ]$$

In Equations 9 and 10, μ_{d} and μₕ are parameter update gains (constants), and n is a variable that defines a rule by which an update amount decreases as a compensation output increases.

The third calculation unit 133 may limit a maximum value of the disturbance parameter according to a preset first reference value and limit a minimum value of the frequency response parameter according to a preset second reference value.

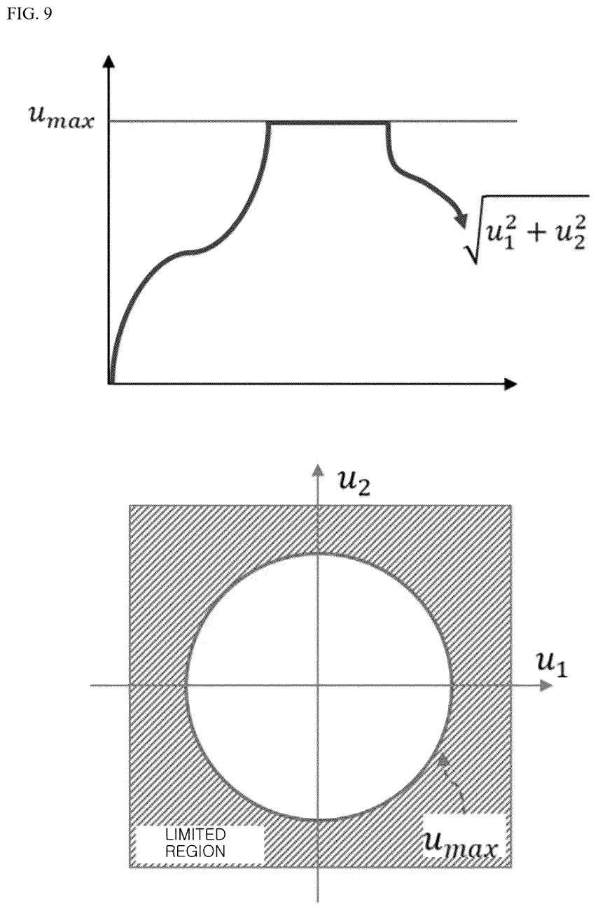

Referring to FIG. 8, the third calculation unit 133 may set the minimum value of the frequency response parameter to prevent an inverse matrix of the system frequency response parameter from being eliminated and maintain the value of the system frequency response parameter at or above the minimum value through scaling compensation when the inverse matrix of the system frequency response parameter is less than the minimum value.

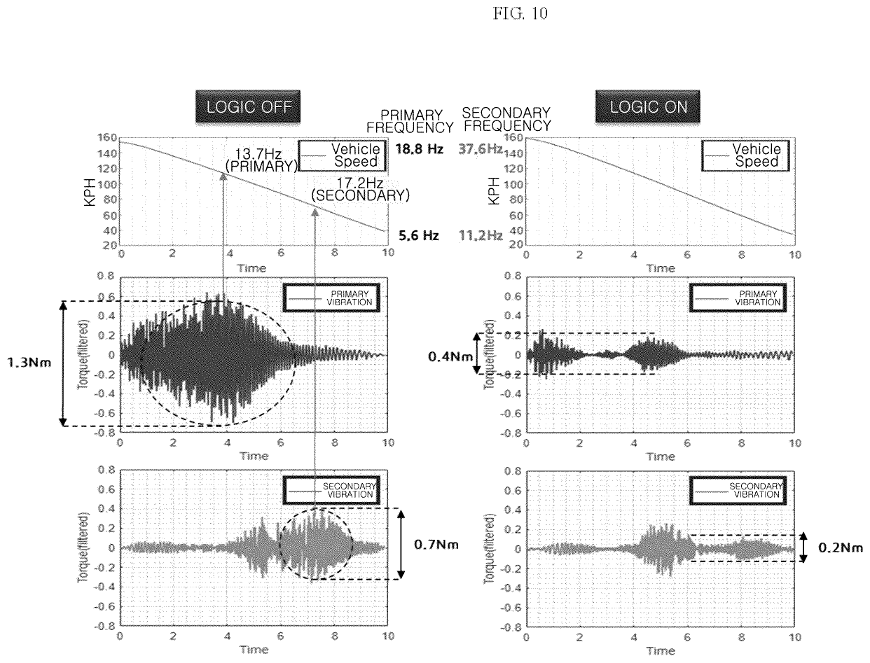

Referring to FIG. 9, the third calculation unit 133 may set a maximum value to prevent the value of the disturbance parameter and the value of the compensation signal calculated through the value of the disturbance parameter from going beyond a system range and maintain the value of the disturbance parameter at or below the maximum value through scaling compensation when the value of the disturbance parameter exceeds the maximum value.

The compensation signal calculation unit 134 may calculate the disturbance compensation signal (u1k cos θ+u2k sin θ) through a product operation between the matrix value of the disturbance parameter and the inverse matrix value of the frequency response parameter.

The EPS system may output a motor current command using an EPS control logic signal and the disturbance compensation signal.

Alternatively, the EPS system may output a motor current command using the EPS control logic signal, the disturbance compensation signal, and the damping control signal.

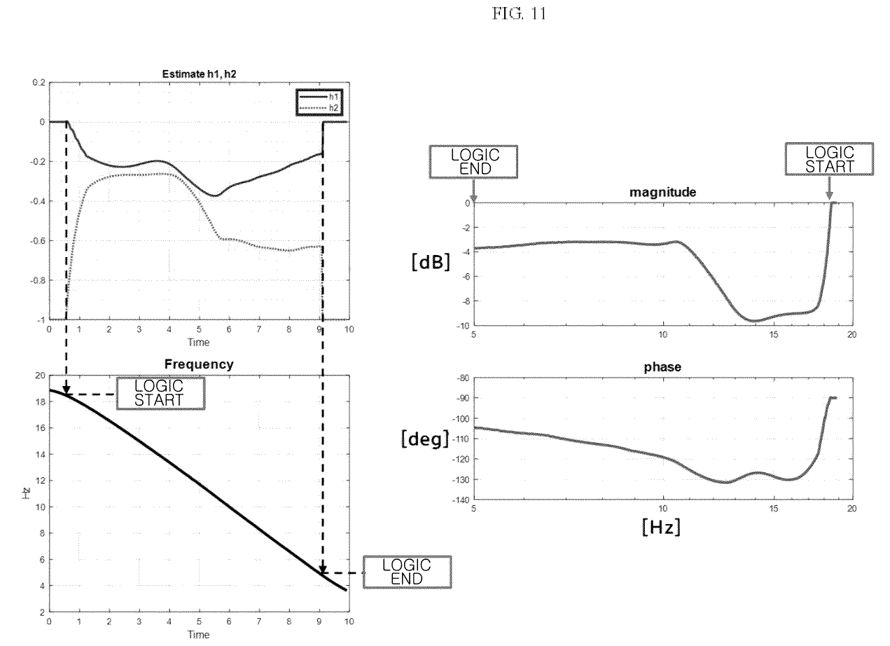

FIGS. 10 and 11 are views for describing test results of the vibration reduction apparatus of an EPS system according to the embodiment.

FIGS. 10 and 11 are graphs showing the vibration reduction performance that occurs when a vehicle traveling at 150 kph is braked at 40 kph. Referring to FIG. 10(a), it is seen that when the vibration reduction apparatus of an EPS system according to the embodiment is not applied in a primary vibration generation process, a measured vibration amount is 1.3 Nm (Newton-meter), whereas when the vibration reduction apparatus of an EPS system according to the embodiment is applied, a measured vibration amount is 0.4 Nm. In addition, it is seen that when the vibration reduction apparatus of an EPS system according to the embodiment is not applied in a secondary vibration generation process, a measured vibration amount is 0.7 Nm (Newton-meter), whereas when the vibration reduction apparatus of an EPS system according to the embodiment is applied, a measured vibration amount is 0.2 Nm. That is, it can be seen that the vibration amount is measured to be reduced by approximately 50 to 67% through the vibration reduction apparatus of an EPS system according to the embodiment.

In FIG. 11, it can be seen that the system frequency response parameters are calculated and updated over time in a test process according to FIG. 10. That is, the vibration reduction apparatus of an EPS system according to the embodiment calculates the disturbance compensation signal by considering the EPS system response by calculating and applying the system frequency response parameters in real time.

The disturbance compensation signal is transmitted to the compensation signal transmission system and converted into torque of the EPS system. The compensation signal transmission system may include any electronic or mechanical device for generating torque, such as an EPS controller, a motor, a motor controller, a gear, and the like, but is not particularly limited thereto.

The steering torque generated by the compensation signal transmission system may be detected by the torque sensor, and the torque signal detected by the torque sensor may be used to compensate for the disturbance of the torque sensor.

The term “˜unit” used in the present embodiment refers to software components or hardware components such as a field-programmable gate array (FPGA) or an application specific integrated circuit (ASIC), and “˜unit” performs certain functions. However, the “˜unit” is not limited to software or hardware. The “˜unit” may be configured to reside in an addressable storage medium, or may be configured to reproduce one or more processors. Therefore, for example, “˜unit” includes components such as software components, object-oriented software components, class components, and task components, and includes processes, functions, attributes, procedures, sub-routines, segments of program code, drivers, firmware, micro code, circuits, data, a database, data structures, tables, arrays, and variables. Functions provided in the components and the “˜unit” may be combined into smaller numbers of components and “˜units,” or may be further divided into additional components and “˜units.” Furthermore, the components and “˜units” may be implemented to reproduce one or more CPUs in a device or a security multimedia card.

A vibration reduction apparatus of an EPS system according to an embodiment can minimize or eliminate disturbance affecting the performance of the EPS system.

In addition, a system frequency response can be estimated to offset its effect.

In addition, disturbance vibrations can be stably suppressed even at a resonance frequency of the system.

Although preferred embodiments of the present invention have been described above, it is understood that those skilled in the art can make various changes and modifications to the present invention without departing from the spirit and scope of the present invention set forth in the claims below.

What is claimed is:

1. A vibration reduction apparatus of an electric power steering (EPS) system, comprising:
a filter configured to extract a disturbance frequency signal from a torque signal detected by a torque sensor of the EPS system; and
an adaptive controller configured to estimate a disturbance parameter and a frequency response parameter of the EPS system using a vibration frequency of a disturbance of the EPS system and the disturbance frequency signal, and calculate a disturbance compensation signal using the disturbance parameter and the frequency response parameter.

2. The vibration reduction apparatus of claim 1, wherein the adaptive controller includes:
a first calculation unit configured to calculate error partial differentiation of the vibration frequency and the disturbance compensation signal;
a second calculation unit configured to calculate the disturbance parameter and the frequency response parameter using a calculation result of the error partial differentiation and the disturbance frequency signal; and
a compensation signal calculation unit configured to calculate the disturbance compensation signal using the disturbance parameter and the frequency response parameter.

3. The vibration reduction apparatus of claim 2, wherein the second calculation unit calculates the disturbance parameter and the frequency response parameter through a calculation process of minimizing an objective function of the torque signal from the calculation result of the error partial differentiation and the disturbance frequency signal.

4. The vibration reduction apparatus of claim 3, wherein the adaptive controller further includes a third calculation unit configured to limit a maximum value of the disturbance parameter according to a preset first reference value and limit a minimum value of the frequency response parameter according to a preset second reference value.

5. The vibration reduction apparatus of claim 4, wherein the compensation signal calculation unit calculates the disturbance compensation signal through a product operation between a matrix value of the disturbance parameter and an inverse matrix value of the frequency response parameter.

6. The vibration reduction apparatus of claim 1, wherein the EPS system outputs a motor current command using an EPS control logic signal and the disturbance compensation signal.

7. The vibration reduction apparatus of claim 1, further comprising a system damping controller configured to control an amount of change in at least one of a magnitude and a phase at a resonance frequency of the EPS system using the torque signal as an input.

8. The vibration reduction apparatus of claim 7, wherein the system damping controller outputs a damping control signal that limits the amount of change in at least one of the magnitude and the phase at the resonance frequency of the EPS system to within a preset range using the torque signal as the input.

9. The vibration reduction apparatus of claim 8, wherein the EPS system outputs a motor current command using an EPS control logic signal, the disturbance compensation signal, and the damping control signal.
